(19) United States
(12) Patent Application Publication
(10) Pub. No.: US 2026/0332710 A1
(43) Pub. Date: Oct. 22, 2026

(54) IMAGE READING APPARATUS

(71) Applicant: BROTHER KOGYO KABUSHIKI KAISHA, Nagoya (JP)

(72) Inventor: Thanh NGUYENVAN, Nagoya (JP)

(21) Appl. No.: 19/566,975

(22) Filed: Mar. 14, 2026

(30) Foreign Application Priority Data
Apr. 17, 2025 (JP) 2025-067908

(51) Int. Cl. H04N 1/00

(52) U.S. Cl. CPC H04N 1/00798; H04N 1/0057

(57) ABSTRACT

An image reading apparatus includes: a document conveying device automatically conveys a document; a user interface; and a reading device. The image reading apparatus being capable of causing the reading device to read an image of a document and generating read data based on a reading result. The image reading apparatus being capable of performing continuation setting as to whether to enable or disable continuous reading. After the image of the document is read, if the continuous reading is set, the image reading apparatus waits to receive a continuation instruction. When the continuation instruction is received, an image of a next document is read, and when the continuation instruction is not received, the image reading apparatus combines and outputs the read data. When the continuous reading is not set and a continuation suggestion condition is satisfied, the user interface displays continuation suggestion information suggesting the continuous reading.

### REFERENCE TO RELATED APPLICATIONS

This application claims priority from Japanese Patent Application No. 2025-067908 filed on Apr. 17, 2025. The entire contents of the priority application are incorporated herein by reference.

### BACKGROUND ART

In a related art, an image reading apparatus including an automatic document conveying device (ADF) is known. A known image reading apparatus performs reading by the ADF.

The related art discloses an image reading apparatus capable of performing continuous reading. In the disclosed image reading apparatus, when the start of reading is instructed, either an ADF reading method or an FB reading method is selected to perform reading of a document. Every time one reading is completed, the image reading apparatus receives a user designation as to whether to perform reading continuously, and when the continuation is designated, either the ADF reading method or the FB reading method is selected to perform reading of the document.

An image reading apparatus capable of enabling or disabling continuous reading does not perform continuous reading unless continuous reading is enabled. Since there is a user who does not recognize the setting of continuous reading, a new technique for promoting the use of continuous reading is desired.

### SUMMARY

An image reading apparatus for solving the problem includes: a document conveying device configured to automatically convey a document; a user interface; and a reading device, the image reading apparatus is capable of causing the reading device to read an image of a document conveyed by the document conveying device and generating read data based on a reading result, and the image reading apparatus is capable of performing continuation setting as to whether to enable or disable continuous reading in accordance with an operation via the user interface. The image reading apparatus is configured to: after causing the reading device to read the image of the document conveyed by the document conveying device, if the continuous reading is set to be enabled as the continuation setting, enter a state of waiting to receive the continuation instruction via the user interface; when the continuation instruction is received in a state of waiting to receive the continuation instruction, cause the reading device to read an image of a next document; when the continuation instruction is not received in a state of waiting to receive the continuation instruction, combine and output read data obtained by reading; if the continuous reading is set to be disabled as the continuation setting, not enter a state of waiting to receive the continuation instruction, and combine and output read data obtained by reading. The image reading apparatus is further configured to, if the continuous reading is set to be disabled as the continuation setting and a continuation suggestion condition is satisfied, cause the user interface to display continuation suggestion information suggesting the continuous reading.

### BRIEF DESCRIPTION OF DRAWINGS

FIG. 1 is a diagram illustrating a schematic configuration of an MFP.

FIG. 2 is a diagram illustrating an example of a configuration of a cover.

FIG. 3 is a flowchart illustrating an example of a procedure of a reading process.

FIG. 4A is a diagram illustrating an example of a scan setting screen.

FIG. 4B is a diagram illustrating an example of a scan setting screen.

FIG. 5 is a flowchart illustrating an example of a procedure of an ADF reading process.

FIG. 6A is a diagram illustrating an example of a continuation reception screen.

FIG. 6B is a diagram illustrating an example of a continuation reception screen.

FIG. 7A is a diagram illustrating an example of a continuous scan function information screen.

FIG. 7B is a diagram illustrating an example of a continuous scan function information screen.

FIG. 8 is a flowchart illustrating an example of a procedure of the ADF reading process.

FIG. 9 is a flowchart illustrating an example of a procedure of the ADF reading process.

FIG. 10 is a diagram illustrating a schematic configuration of an MFP.

FIG. 11 is a flowchart illustrating an example of a procedure of the ADF reading process.

FIG. 12 is a flowchart illustrating an example of a procedure of the ADF reading process.

### DESCRIPTION

Hereinafter, a first embodiment embodying an image reading apparatus will be described in detail with reference to the accompanying drawings. The present specification discloses a multi function device (hereinafter, referred to as an “MFP”) having an image reading function.

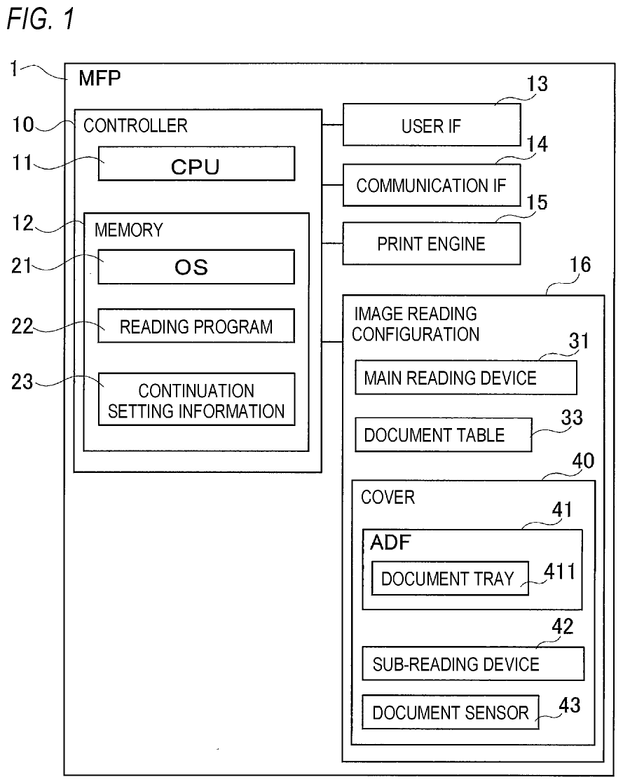

As illustrated in FIG. 1, an MFP 1 according to the present embodiment includes, for example, a controller 10 including a CPU 11 and a memory 12. The MFP 1 includes a user interface (hereinafter, referred to as a “user IF”) 13, a communication interface (hereinafter, referred to as a “communication IF”) 14, a print engine 15, and an image reading configuration 16. The user IF 13, the communication IF 14, the print engine 15, and the image reading configuration 16 are electrically connected to the controller 10. The MFP 1 is an example of the image reading apparatus. The controller 10 in FIG. 1 is a collective term for hardware and software used to control the MFP 1, and does not necessarily represent a single piece of hardware present in the MFP 1.

The CPU 11 of the MFP 1 performs various types of processes, in accordance with a program read from the memory 12 and based on a user operation. The memory 12 of the MFP 1 stores various programs and various data. The various programs include an operating system (hereinafter referred to as “OS”) 21 and a reading program 22. The various data include continuation setting information 23. The memory 12 is used as a work area in a case where various types of processes are executed. A buffer provided in the CPU 11 is also an example of the memory 12. The program and data will be described later in detail.

An example of the memory 12 is not limited to a ROM, a RAM, an HDD, and the like incorporated into the MFP 1, and may be a storage medium configured to be read and written by the CPU 11. For example, an external memory such as a USB memory or an HDD connected to the MFP 1 is also an example of the memory 12. A memory or an HDD provided in a device connected to the MFP 1 via the communication IF 14 is also an example of the memory 12.

The computer-readable storage medium is a non-transitory medium. The non-transitory medium also includes a recording medium such as a CD-ROM or a DVD-ROM, in addition to the above-described examples. The non-transitory medium is also a tangible medium. On the other hand, an electric signal conveying a program downloaded from a server or the like on the Internet is a computer-readable signal medium, but is not included in the non-transitory medium.

The user IF 13 includes, for example, a touch panel. The touch panel includes hardware configured to display a screen for notifying a user of information, and hardware configured to receive an operation from the user. The user IF 13 may include a combination of a display and a hardware button or the like.

The communication IF 14 includes hardware for communicating with an external device. The communication IF 14 has functions compatible with communication standards such as Wi-Fi (registered trademark), Ethernet (registered trademark), and USB. The MFP 1 may include a plurality of communication IFs 14.

The print engine 15 includes a configuration for printing an image on a print medium such as a sheet. An image formation method of the print engine 15 is, for example, an electrophotographic method or an ink-jet method. The MFP 1 according to the present embodiment may include a print engine 15 that is capable of performing color printing using multicolor coloring materials. The MFP 1 according to the present embodiment may include the print engine 15 that performs only monochromatic printing using a monochromatic colorant.

The image reading configuration 16 includes a main reading device 31, a document table 33, and a cover 40. The cover 40 includes a document conveying device (hereinafter referred to as “ADF”) 41 configured to automatically convey a document, a sub-reading device 42, and a document sensor 43. Each of the main reading device 31 and the sub-reading device 42 is an example of a reading device. The main reading device 31 and the sub-reading device 42 may be devices configured to perform color reading for reading a document as a color image. The main reading device 31 and the sub-reading device 42 may be devices capable of performing only monochrome reading.

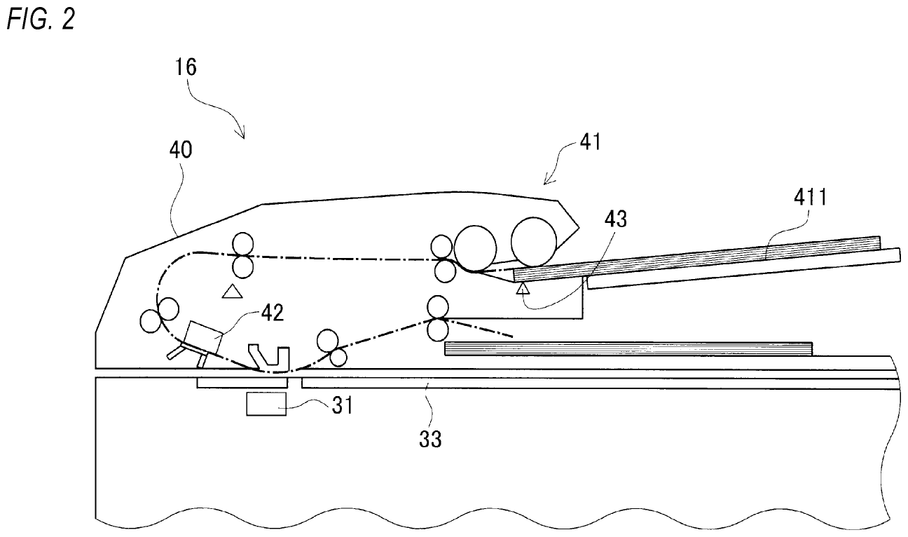

For example, as illustrated in FIG. 2, the document table 33 includes a transparent plate-shaped contact glass provided to be integrally fixed to a housing of the MFP 1. The document table 33 is also referred to as a flat bed (hereinafter, referred to as “FB”). The cover 40 is disposed above the document table 33 and is openable and closable with respect to the document table 33. FIG. 2 illustrates the cover 40 in a closed state. The document table 33 is exposed in an open state of the cover 40, and is not exposed by being covered with the cover 40 in a closed state of the cover 40.

Each of the main reading device 31 and the sub-reading device 42 includes reading elements arranged in a main scanning direction, which is a depth direction in FIG. 2. Both the main reading device 31 and the sub-reading device 42 are configured to read an image of a document. The MFP 1 can read an image of a document using the main reading device 31 or the sub-reading device 42. The MFP 1 can generate read data based on a reading result by reading an image of a document, and perform output based on the generated read data.

The main reading device 31 is disposed at a position below the document table 33 in FIG. 2, and is movable along the document table 33 in a sub-scanning direction, which is a left-right direction in FIG. 2. By using the main reading device 31, the MFP 1 can read an image using two types of reading methods of ADF reading and FB reading.

The ADF reading is a reading method in which conveyance of a document by the ADF 41 and reading of an image of the document are performed in parallel. In the ADF reading, the MFP 1 stops the main reading device 31 at a predetermined position. The MFP 1 conveys the documents placed on the document tray 411 of the ADF 41 one by one by the ADF 41. The document tray 411 is an example of a sheet feed tray. The FB reading is a reading method in which the main reading device 31 is moved in the sub-scanning direction along the document table 33 to read an image of a document placed on the document table 33. The main reading device 31 reads an image on a lower surface of the document on the document table 33 in FIG. 2.

The sub-reading device 42 is disposed to face a conveyance path of the document by the ADF 41 and does not move. The sub-reading device 42 reads an image on a back surface of the document conveyed by the ADF 41, that is, on a surface different from the surface read by the main reading device 31. The MFP 1 can perform double-sided reading for reading images on both sides of the document while conveying the document by the ADF 41. In the double-sided reading, the MFP 1 performs both the reading of a first surface by the main reading device 31 and the reading of a second surface by the sub-reading device 42 in parallel.

The MFP 1 may include a cover sensor that outputs different signals between the open state and the closed state of the cover 40. By providing the cover sensor, the MFP 1 can detect whether the cover is opened or closed based on the signal output from the cover sensor. The document sensor 43 is, for example, a light reflection sensor disposed in the document tray 411 of the ADF 41, and is configured to output different signals depending on whether there is a document on the ADF 41 or there is no document on the ADF 41. The MFP 1 is configured to determine whether a document is detected in the ADF 41 based on the signal output from the document sensor 43.

Next, a procedure for reading an image of a document by the MFP 1 will be described. The following processes basically represent processes of the CPU according to commands written in programs. That is, the processes such as “judgment”, “extraction”, “selection”, “calculation”, “determination”, “specification”, “acquisition”, “reception”, and “control” to be described below represent the processes of the CPU. The processes by the CPU also include hardware control using API of the OS. In the present specification, the description of the OS is omitted, and an operation of each program is described. That is, in the following description, the description that “a program B controls hardware C” may refer to “the program B controls the hardware C, using the API of the OS”. In addition, the processes of the CPU according to the commands written in the programs may be described in omitted words. For example, the processes of the CPU may be described as “the CPU performs”. In addition, the processes of the CPU according to the commands written in the programs may be described in words in which the CPU is omitted, such as “the program A performs”.

In addition, in the present specification, “notification”, “alert”, “notifying”, “reply”, “response”, “answer”, and the like are not limited to a meaning of transmission of information to a person, and are also used as words meaning communication or exchange of information between devices or between components in a device. The configuration in the device includes software.

The term “acquisition” is used as a concept indicating that a request is not essential. That is, a process of receiving data without a request from the CPU is also included in a concept indicating that “the CPU acquires data”. In addition, the term “data” in the present specification is represented by a computer-readable bit string. Furthermore, data having substantially the same meaning and different formats are treated as the same data. The “information” in the present specification may be treated similarly to the “data”. The “information” may be treated to convey the meaning by some method such as a character string, an image, a voice, or the like, instead of a bit string. In addition, the term “request” or “instruct” is a concept indicating that information indicating that a request is being made or information indicating that an instruction is being given is output to a partner. In addition, the information indicating that a request is being made or the information indicating that an instruction is being given is simply referred to as a “request” or “instruction”.

According to the CPU, a process of determining whether information A indicates that it is a matter B may be conceptually described as “determining whether it is the matter B, based on the information A”. According to the CPU, a process of determining whether the information A indicates that it is the matter B or a matter C may be conceptually described as “determining whether it is the matter B or the matter C, based on the information A”.

In the present specification, a setting item may be simply referred to as “setting”. A setting value may be simply referred to as “setting”. The setting value may be described as a “parameter”. Furthermore, storing the setting value in a memory or the like may be simply referred to as “setting”. An operation for setting or input for setting may be simply referred to as “setting”.

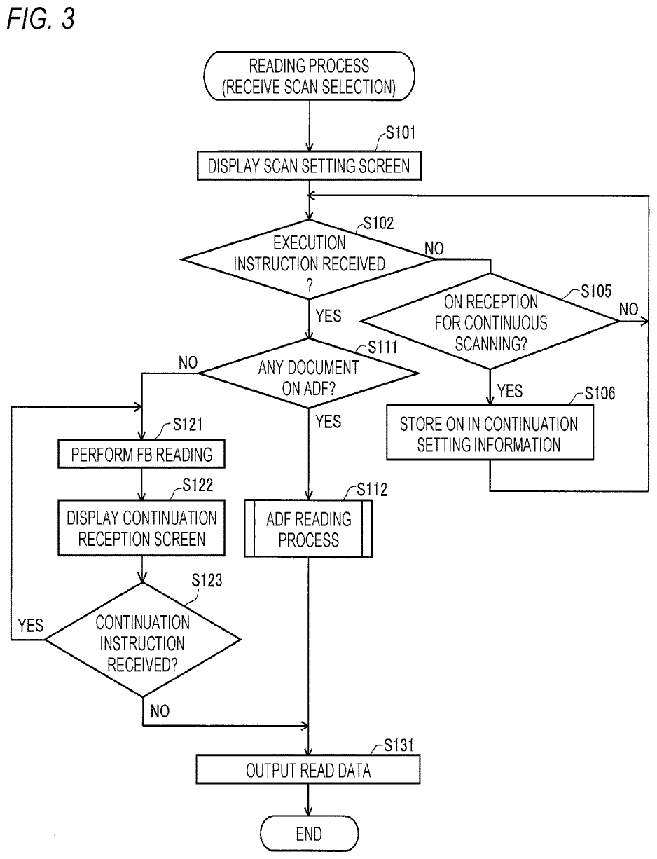

A reading process by the MFP 1 according to the present embodiment will be described with reference to a flowchart of FIG. 3. The reading process is performed in the CPU 11 of MFP 1 when an instruction to select scanning is received in the MFP 1. The MFP 1 is configured to receive an instruction to select scanning by a user operation on an icon indicating scanning on a home screen, for example.

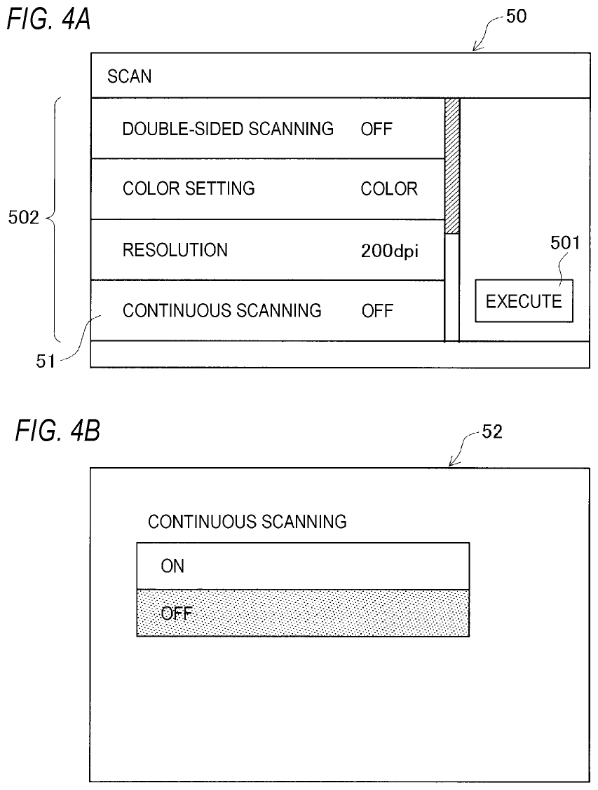

When the scan is selected, for example, as illustrated in FIGS. 4A and 4B, the CPU 11 causes the user IF 13 to display a scan setting screen 50 (S101). The scan setting screen 50 includes an execution button 501 for receiving an instruction to start performing scanning and a plurality of buttons 502 for receiving various settings related to scanning. The plurality of buttons 502 include a continuous scanning button 51 for receiving an instruction of a continuation setting of enabling or disabling continuous reading.

The CPU 11 determines whether an instruction to start performing scanning by an operation on the execution button 501 is received (S102). In response to determining that the instruction to start performing scanning is not received (S102: NO), the CPU 11 determines whether an operation on a button other than the execution button 501 is received. For example, the CPU 11 determines whether an operation on the continuous scanning button 51 is received.

In response to determining that a setting instruction of the continuation setting is received by the operation on the continuous scanning button 51, the CPU 11 displays a continuous scanning screen 52 as illustrated in FIG. 4B. The continuous scanning screen 52 is a screen capable of receiving a selection of either continuous ON or continuous OFF, and is a screen capable of receiving a user selection. Then, the CPU 11 determines whether an instruction to set the continuous ON as the continuation setting is received (S105). The continuous ON is a setting for enabling continuous reading, and the continuous OFF is a setting for disabling continuous reading. In MFP 1, as illustrated in FIGS. 4A and 4B, continuous OFF is set as the default of the continuation setting.

In response to determining that the instruction to set the continuous ON is received, specifically, when an operation to “ON” on the continuous scanning screen 52 is received (S105: YES), the CPU 11 stores information indicating the continuous ON in the continuation setting information 23 (see FIG. 1) (S106). Further, the CPU 11 displays, on the continuous scanning button 51 of the scan setting screen 50, “ON” indicating the continuous ON.

After S106, or in response to determining that the instruction to set the continuous scanning is not received (S105: NO), the CPU 11 proceeds to S102. The CPU 11 determines whether an instruction to start performing scanning by an operation on the execution button 501 is received. The CPU 11 can receive various setting instructions according to the operation on the other button 502 at any time until the CPU 11 receives the operation on the execution button 501. Then, the CPU 11 stores the selected information in the memory 12 each time a user operation is received.

In response to determining that the operation on the execution button 501 is received (S102: YES), the CPU 11 determines whether there is a document in the ADF 41 (S111). The CPU 11 performs the determination in S111 based on, for example, the signal from the document sensor 43. In response to determining that there is a document on the ADF 41 (S111: YES), the CPU 11 performs an ADF reading process (S112).

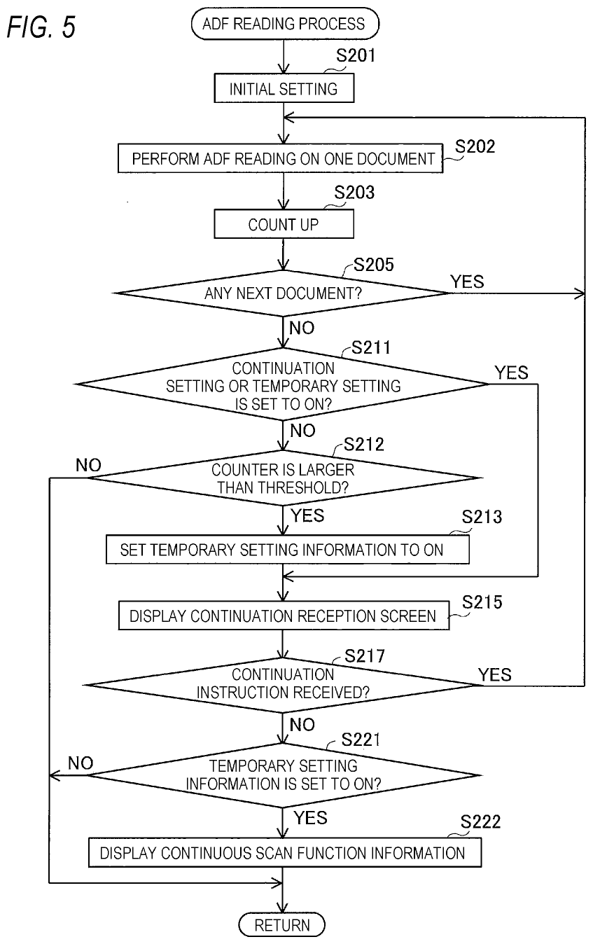

A procedure of the ADF reading process will be described with reference to a flowchart of FIG. 5. In the ADF reading process, the CPU 11 performs an initial setting (S201). Specifically, the CPU 11 clears the counter and turns off temporary setting information. The counter is information for counting the number of documents read by the ADF reading. The temporary setting information is information stored when the continuation setting is temporarily turned on. The CPU 11 causes the ADF 41 to convey one document, performs ADF reading (S202), and counts up (S203). The CPU 11 generates read data by the ADF reading and temporarily stores the read data in the memory 12.

When an image of one document is conveyed, the CPU 11 determines whether there is another document on the ADF 41 based on the signal from the document sensor 43 (S205). A plurality of documents can be placed on the ADF 41 at a time, and if there is one or more documents, the document sensor 43 outputs a signal indicating that there is a document. In response to determining that there is a document on the ADF 41 (S205: YES), the CPU 11 conveys a next one document, performs the ADF reading, and counts up (S202, S203).

In response to determining that there is no document placed in the ADF 41 (S205: NO), the CPU 11 determines whether the continuation setting or the temporary setting is set to continuous ON (S211). The continuation setting is a setting that can be accepted by an operation on the scan setting screen 50 described above. The temporary setting will be described later.

In response to determining that neither the continuation setting nor the temporary setting is set to continuous ON (S211: NO), the CPU 11 determines whether a value of the counter is larger than a threshold (S212). That is, the CPU 11 determines whether the number of documents read by the current ADF reading is larger than a predetermined threshold. The threshold is a predetermined number of documents equal to or larger than three and equal to or smaller than the maximum number of documents that can be set in the ADF 41. The threshold is equal to or larger than half of the maximum number of documents that can be set in the ADF 41, and may be, for example, 80% documents that is the maximum number of documents that can be set in the ADF 41. The threshold used in S212 is an example of a threshold number of documents.

The CPU 11 conveys the document by the ADF 41 and counts the number of documents by the counter. After causing the main reading device 31 to read the images of all the documents set in the ADF 41, the CPU 11 determines whether the number of documents is larger than a threshold. Therefore, the CPU 11 can accurately grasp the number of documents set in the ADF 41.

In response to determining that the value of the counter is larger than the threshold (S212: YES), the CPU 11 sets the temporary setting information to ON (S213). A condition that the value of the counter is larger than the threshold is an example of a continuation suggestion condition. The temporary setting information is information indicating that the continuation suggestion condition is satisfied.

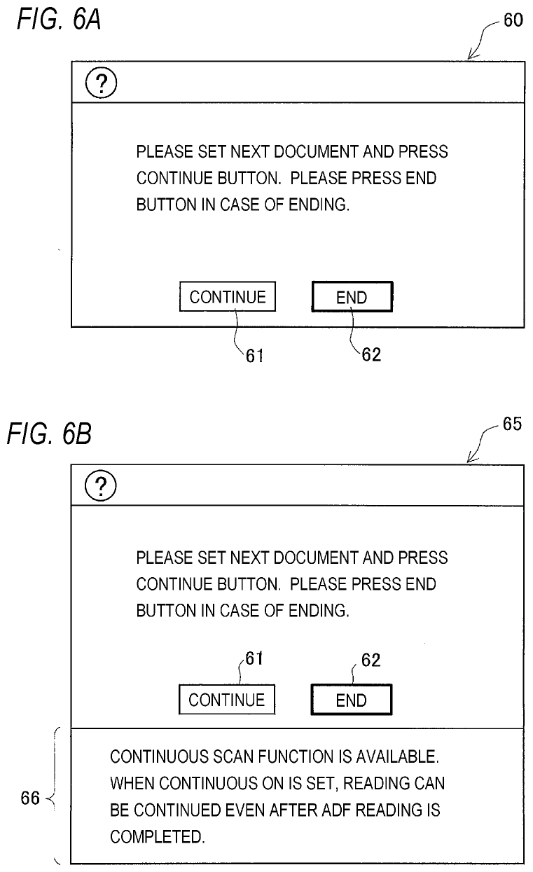

After S213, or in response to determining that the continuation setting or the temporary setting is set to continuous ON (S211: YES), the CPU 11 causes the user IF 13 to display a continuation reception screen (S215). For example, as illustrated in FIG. 6A, the CPU 11 causes the user IF 13 to display a continuation reception screen 60 including a continue button 61 and an end button 62, and receives a user operation. The continuation reception screen 60 is an example of a selection screen and an example of a first selection screen.

The CPU 11 determines whether a continuation instruction is received by an operation on the continue button 61 (S217). The operation on the continue button 61 is an example of an operation of instructing continuous reading. The continuation reception screen 60 is an example of a screen capable of receiving the operation of instructing continuous reading. The state in which the continuation reception screen 60 is displayed on the user IF 13 is an example of a state of waiting to receive a continuation instruction.

The CPU 11 may display different screens depending on whether the continuation setting is set to continuous ON or the continuation setting is set to continuous OFF and the temporary setting is set to ON. When the continuation setting is set to continuous OFF and the temporary setting is set to ON, the user may not recognize a function of continuous scanning. When the temporary setting is set to ON, the CPU 11 may display, for example, a continuation reception screen 65 illustrated in FIG. 6B. The continuation reception screen 65 illustrated in FIG. 6B includes a continue button 61 and an end button 62, and includes function information 66 for explaining the function of continuous scanning. The continuation reception screen 65 is an example of a second selection screen.

The function information 66 is information suggesting to the user that the MFP 1 has a continuous scan function, and is an example of continuation suggestion information. When the number of documents set in the ADF 41 is large, there is a possibility that a large number of documents are divided into a plurality of document bundles and set in the ADF 41. By displaying information describing a function of the continuous reading, the user can understand the continuous reading function and can easily use the continuous reading.

When the number of read documents is large after the ADF reading, the CPU 11 can display the continuation reception screen 65 including the function information 66. By displaying the continuation reception screen 65, the CPU 11 can notify the function of continuous scanning and can receive the operation of instructing continuous reading. Therefore, it is possible to receive a continuous reading instruction for the current reading, and it is possible to use the next and subsequent continuous reading.

On the other hand, when the continuation setting is set to continuous ON, the user is highly likely to recognize the function of continuous scanning. When the continuation setting is set to continuous ON, a screen is simplified by displaying the continuation reception screen 60 illustrated in FIG. 6A.

In the continuation reception screen 60 illustrated in FIG. 6A, the end button 62 is selected as a default. That is, when an instruction to close the continuation reception screen 60 is received without receiving an operation on the continue button 61 or an operation on the end button 62, the CPU 11 determines that the operation on the end button 62 is received. There is a possibility that the user who has already recognized the continuous reading may intentionally disable the continuous reading. In the selection of whether to continue according to the continuation suggestion information, it is preferable to set not to continue as a default.

For example, the MFP 1 may be configured to receive a setting of a threshold by an administrator or the like. For example, when an instruction to set a threshold is received, the MFP 1 stores information on the received threshold in the memory 12. When the threshold is stored in the memory 12, the CPU 11 may compare the threshold stored in the memory 12 with the value of the counter in S212. If the threshold is a settable variable value, the administrator can adjust the frequency of displaying the continuation reception screen 60 or the continuation reception screen 65 by changing the threshold.

The CPU 11 determines whether the continuation instruction is received by an operation on the continue button 61 (S217). In response to determining that the continuation instruction is received (S217: YES), the CPU 11 proceeds to S202 and subsequently performs ADF reading.

When the continuation instruction is received and the ADF reading is continuously performed, the CPU 11 repeatedly performs reading until there is no document placed on the ADF 41 (S205: NO). In the second and subsequent ADF reading, the CPU 11 may or may not count up the number of documents.

In a case where there is no document on the ADF 41 when the operation on the continue button 61 is received, the CPU 11 may display the continuation reception screens 60 and 65 again. Alternatively, the CPU 11 may end the scanning when there is no document in the ADF 41. In the continuation reception screen 60, 65, the CPU 11 may be displayed in a state in which the end button 62 is selected as a default. For example, when an operation of closing a screen is received without receiving an operation on either the continue button 61 or the end button 62, the CPU 11 may determine that the operation on the end button 62 is received.

When all the set documents are read for the second and subsequent times (S205: NO), the CPU 11 determines whether the continuous ON or the temporary setting ON is stored (S211). In response to determining that the continuous ON or the temporary setting ON is stored (S211: YES), the CPU 11 causes the user IF 13 to display the continuation reception screen 60 (S215). In the second and subsequent S215, the CPU 11 may display the continuation reception screen 60 not including the function information 66.

If the result of the first S211 is NO and the number of documents exceeds the threshold, the CPU 11 turns on the temporary setting in S213. That is, when a large number of documents are read in the first ADF reading, the CPU 11 displays the continuation reception screen 60 every time after the second and subsequent ADF reading. The CPU 11 repeats S202 to S217 until an operation on the end button 62 is received on the continuation reception screen 60.

In response to determining that the operation on the end button 62 is received on the continuation reception screen 60 (S217: NO), the CPU 11 determines whether the temporary setting information is set to ON (S221). When the continuation setting is set to continuous OFF and the value of the counter is larger than the threshold, the CPU 11 sets the temporary setting information to ON in S213. In response to determining that the temporary setting information is set to ON (S221: YES), the CPU 11 causes the user IF 13 to display a screen including the continuous scan function information (S222). A condition that the value of the counter is larger than the threshold, that is, the number of documents set for the first time is larger than the threshold is an example of the continuation suggestion condition.

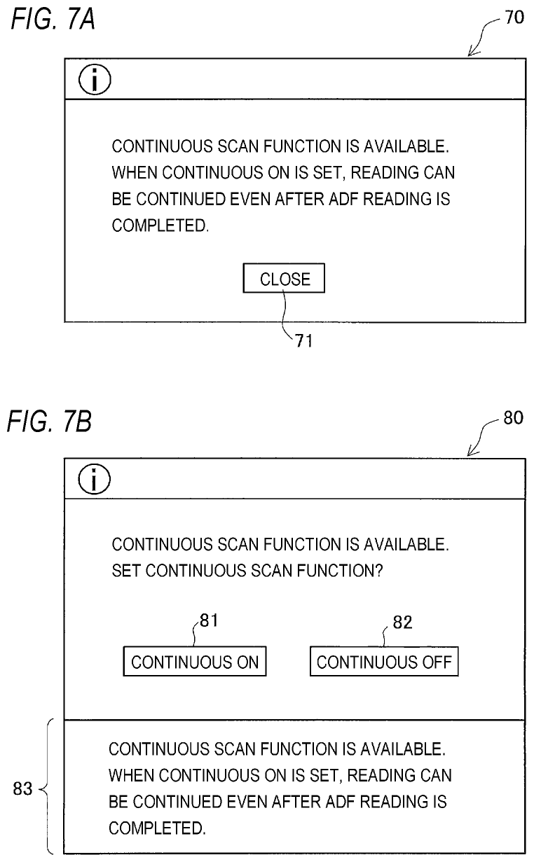

For example, as illustrated in FIG. 7A, the CPU 11 causes the user IF 13 to display a continuous scan function information screen 70 for notifying that the setting of the continuous scanning can be received. The continuous scan function information screen 70 is information suggesting to the user that the MFP 1 has the continuous scan function, and is an example of continuation suggestion information. When the number of read documents is large after the ADF reading, the MFP 1 displays the continuous scan function information screen 70. Therefore, it can be expected to use the subsequent continuous reading. The continuous scan function information screen 70 includes, for example, a close button 71. When an operation on the close button 71 is received, the CPU 11 closes the continuous scan function information screen 70.

The CPU 11 may display the continuous scan function information screen 70 not only when the temporary setting information is ON but also only when the continuation instruction is received. For example, the CPU 11 may not display the continuous scan function information screen 70 when the operation on the continue button 61 is not received even once on the displayed continuation reception screen 60. By displaying the description of the function of continuous reading when the selection to continue is received, the function can be described to the user who needs continuous reading.

In S222, the CPU 11 may display an information screen capable of receiving not only the notification of the continuous scan function but also the setting of the continuous scanning. For example, as illustrated in FIG. 7B, the CPU 11 may display a continuous scan function information screen 80 including a continuous ON button 81, a continuous OFF button 82, and function information 83. Similar to the “ON” button on the continuous scanning screen 52 (FIG. 4B), the continuous ON button 81 is a button for receiving an instruction to set the continuous ON as the continuation setting. The continuous OFF button 82 is a button for receiving an instruction not to set continuous ON as the continuation setting.

The function information 83 is information suggesting to the user that the MFP 1 has a continuous scan function, and is an example of continuation suggestion information. By displaying information describing a function of the continuous reading, the user can understand the continuous reading function and can easily use the continuous reading. When the number of read documents is large after the ADF reading, the MFP 1 can display the continuous scan function information screen 80 including the function information 83. Therefore, it can be expected to use the subsequent continuous reading.

The CPU 11 receives an operation on either the continuous ON button 81 or the continuous OFF button 82. When an operation on the continuous ON button 81 is received, the CPU 11 stores information indicating continuous ON in the continuation setting information 23 (see FIG. 1) and closes the continuous scan function information screen 80. When the operation on the continuous OFF button 82 is received, the CPU 11 closes the continuous scan function information screen 80.

After S222 or in response to determining that the temporary setting information is not set to ON (S221: NO), the CPU 11 ends the ADF reading process. When the temporary setting information is not ON, since the setting of the continuous scanning is set to continuous ON, the CPU 11 does not need to display a continuous scan function information screen.

When the number of documents does not exceed the threshold in the first ADF reading (S212: NO), the CPU 11 ends the ADF reading process without displaying the continuation reception screen 60. When the number of documents is not large from the first time, the possibility that the continuous scan function is used is low. Since some users feel annoyed with the display, the CPU 11 does not display information of the continuous scan function when the number of documents is not large.

Returning to the description of the reading process in FIG. 3. After the ADF reading process of S112, the CPU 11 outputs the read data obtained by the reading up to here (S131). When reading is performed a plurality of times, for example, the CPU 11 combines a plurality of pieces of read data to create an output file and outputs the created file. For example, when an output to the USB memory is designated as the scan setting, the CPU 11 writes the created file to the USB memory connected to the MFP 1. Then, the CPU 11 ends the reading process.

On the other hand, in response to determining that there is no document on the ADF 41 when the instruction to start performing scanning is received (S111: NO), the CPU 11 performs FB reading (S121). That is, the CPU 11 moves the main reading device 31 along the document table 33 and reads an image of a document placed on the document table 33.

When the image of one document is read by the FB reading, the CPU 11 displays the continuation reception screen 60 illustrated in FIGS. 6A and 6B on the user IF 13 (S122). As in S217 of the ADF reading process, the CPU 11 receives an instruction from the user (S123). In response to determining that the continuation instruction by the operation on the continue button 61 is received (S123: YES), the CPU 11 performs the FB reading again (S121). After the FB reading, the CPU 11 displays the continuation reception screen 60 again. Since there is a high possibility that the reading is continuously performed after the FB reading, the CPU 11 can receive the continuation instruction.

In response to determining that the operation on the end button 62 is received on the displayed continuation reception screen 60 (S123: NO), the CPU 11 outputs the read data (S131). After the FB reading, the CPU 11 creates and outputs a file in the same manner as after the ADF reading. Then, the CPU 11 ends the reading process.

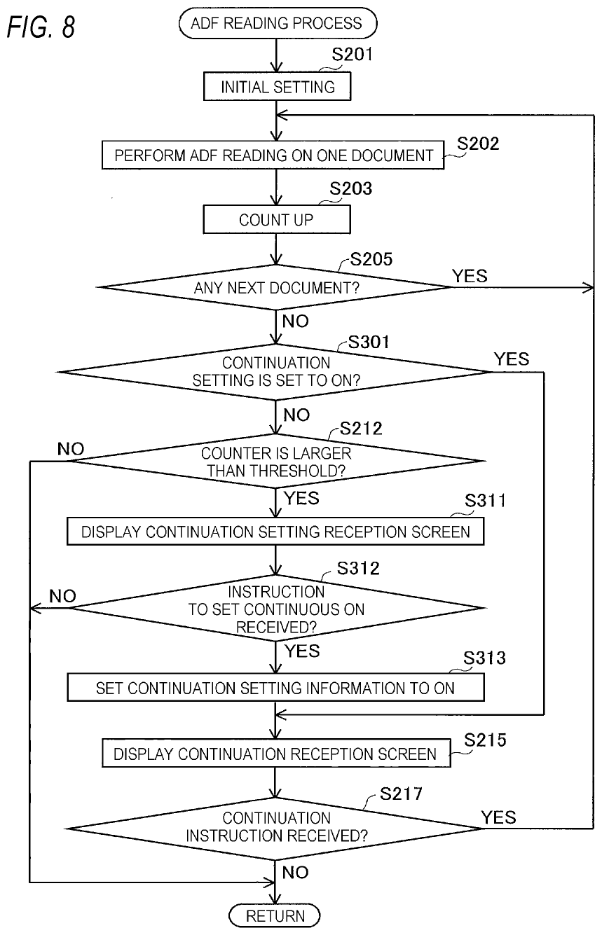

The ADF reading process may be performed according to a procedure illustrated in the flowchart of FIG. 8. In the ADF reading process of FIG. 8, the CPU 11 does not use the temporary setting information. The procedure of the ADF reading process in FIG. 8 is different from a procedure of the ADF reading process in FIG. 5 in which whether to continue is first received. In the ADF reading process of FIG. 8, when the number of documents set in the ADF 41 for the first time is larger than the threshold, the CPU 11 displays a screen capable of receiving the setting instruction of the continuation setting. In FIG. 8, the same reference numerals are given to the same procedure as that of the ADF reading process of FIG. 5, and the description thereof will be omitted.

In the ADF reading process of FIG. 8, the CPU 11 also reads the document set in the ADF 41 and counts the number of documents (S201 to S205). When all the documents set in ADF 41 are read (S205: NO), the CPU 11 determines whether the continuation setting is set to continuous ON (S301). The CPU 11 determines whether the continuous ON is stored in the continuation setting information 23 stored in the memory 12.

In response to determining that the continuous ON is not set (S301: NO), the CPU 11 determines whether the number of read documents is larger than a threshold (S212). In response to determining that the number of documents is larger than the threshold (S212: YES), the CPU 11 causes the user IF 13 to display a continuation setting reception screen (S311). The CPU 11 receives a user operation.

For example, as illustrated in FIG. 7B, the CPU 11 displays the continuous scan function information screen 80 including the continuous ON button 81, the continuous OFF button 82, and the function information 83. The CPU 11 determines whether an instruction to set the continuous ON as the continuation setting is received by the operation on the continuous ON button 81 (S312). In response to determining that the instruction to set the continuous ON as the continuation setting is received (S312: YES), the CPU 11 stores information indicating the continuous ON in the continuation setting information 23 (see FIG. 1) (S313).

After S313 or in response to determining that the continuous ON has already been stored (S301: YES), the CPU 11 causes the user IF 13 to display the continuation reception screen 60 illustrated in FIG. 6A (S215). In response to determining that the continuation instruction is received on the continuation reception screen 60 (S217: YES), the CPU 11 proceeds to S202 and performs the ADF reading.

On the other hand, when the number of documents is not larger than the threshold (S212: NO), the CPU 11 ends the ADF reading process of FIG. 8. When the continuation setting is set to continuous ON (S312: NO), the CPU 11 ends the ADF reading process of FIG. 8. When the continuation instruction is not received (S217: NO), the CPU 11 ends the ADF reading process of FIG. 8.

When the number of read documents is large after the ADF reading, the CPU 11 displays the continuous scan function information screen 80 (FIG. 7B) including the function information 83. By displaying the continuous scan function information screen 80, the CPU 11 can receive the instruction to set the continuous ON as the continuation setting. Therefore, it can be expected to use the subsequent continuous reading. When the instruction to set the continuous ON as the continuation setting is received, the CPU 11 displays the continuation reception screen 60 (FIG. 6A). By displaying the continuation reception screen 60 (FIG. 6A), the CPU 11 can receive the operation of instructing continuous reading. Therefore, the user can read the next document following the current reading.

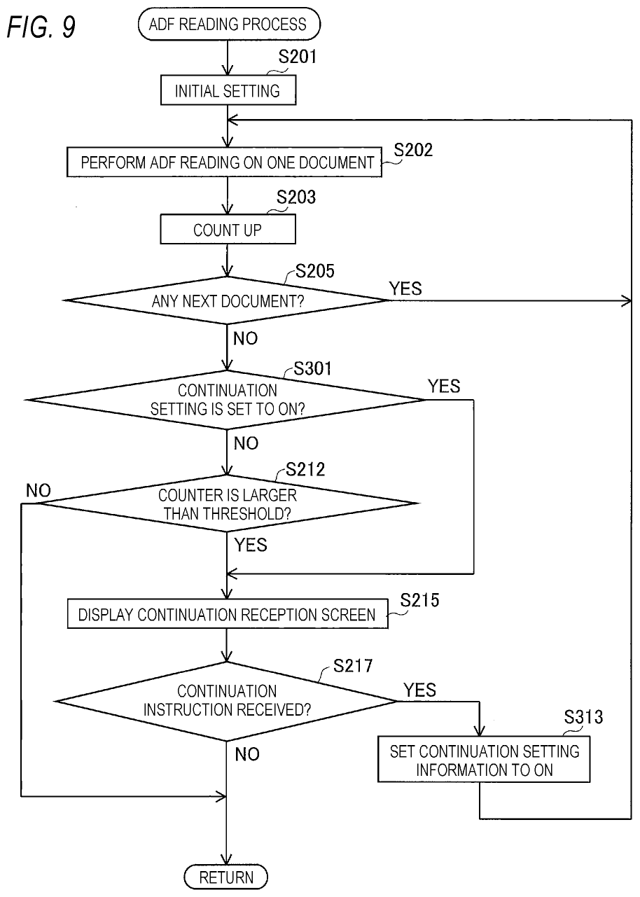

The ADF reading process may be performed according to a procedure illustrated in the flowchart of FIG. 9. The procedure of FIG. 9 is different from the ADF reading process of FIG. 5 in which whether to continue is received first. In the ADF reading process of FIG. 9, when the number of documents is large and an instruction to continue is received, the CPU 11 automatically sets the continuous ON as the continuation setting. The procedure of FIG. 9 is different from the ADF reading process of FIG. 8 in which the continuous ON of the continuation setting and the presence or absence of the continuation of this time are separately received. In FIG. 9, the same reference numerals are given to the same procedure as that of the ADF reading process of FIG. 5 or the ADF reading process of FIG. 8, and the description thereof will be omitted.

In the ADF reading process of FIG. 9, the CPU 11 also reads the document set in the ADF 41 and counts the number of documents (S201 to S205). When all the documents set in ADF 41 are read (S205: NO), the CPU 11 determines whether the continuation setting is set to continuous ON (S301). The CPU 11 determines whether the continuous ON is stored in the continuation setting information 23 stored in the memory 12.

In response to determining that the continuous ON is not set (S301: NO), the CPU 11 determines whether the number of read documents is larger than the threshold (S212). In response to determining that the number of documents is larger than the threshold (S212: YES), the CPU 11 causes the user IF 13 to display a continuation reception screen (S215). The CPU 11 displays, for example, the continuation reception screen 60 illustrated in FIG. 6A or the continuation reception screen 65 illustrated in FIG. 6B. The CPU 11 determines whether the continuation instruction is received by the user operation (S217).

In response to determining that the continuation instruction is received (S217: YES), the CPU 11 stores information indicating continuous ON in the continuation setting information 23 (see FIG. 1) (S313). That is, when the operation of instructing continuous reading is received, the CPU 11 automatically changes the setting of continuous reading to be enabled. If the setting of the continuous reading is automatically changed to be enabled, the subsequent reading is also continuous reading, and the use of the continuous reading is promoted.

Before S313, the CPU 11 may display the continuous scan function information screen 80 illustrated in FIG. 7B and receive the user operation. That is, when determining YES in S217, the CPU 11 may perform S311 and S312 of the ADF reading process of FIG. 8. When the operation of instructing continuous reading is received, the CPU 11 may also receive an operation of changing the setting of continuous reading to be enabled. By changing the setting of the continuous reading to be valid based on the instruction from the user, the intention of the user is reflected, and the use of the continuous reading is promoted.

As described above in detail, the MFP 1 according to the first embodiment displays the continuous scan function information when the continuation setting is set to continuous OFF and the number of documents read by the ADF reading is large. When the number of documents read by the ADF reading is large, the user may divide a large number of documents into a plurality of document bundles and set the documents in the ADF 41. For example, the MFP 1 displays the continuous scan function information including the function information 66 illustrated in FIG. 6B and the function information 83 illustrated in FIG. 7B. By displaying the continuous scan function information, the user can recognize that the MFP 1 has a continuous scan function. Therefore, it can be expected that the recognized user uses continuous reading.

Hereinafter, a second embodiment embodying an image reading apparatus will be described in detail with reference to the accompanying drawings. The MFP 1 according to the second embodiment is different from the MFP 1 according to the first embodiment including the ADF 41 including the fixed document tray 411. The MFP 1 according to the second embodiment includes the ADF 41 including a movable document tray.

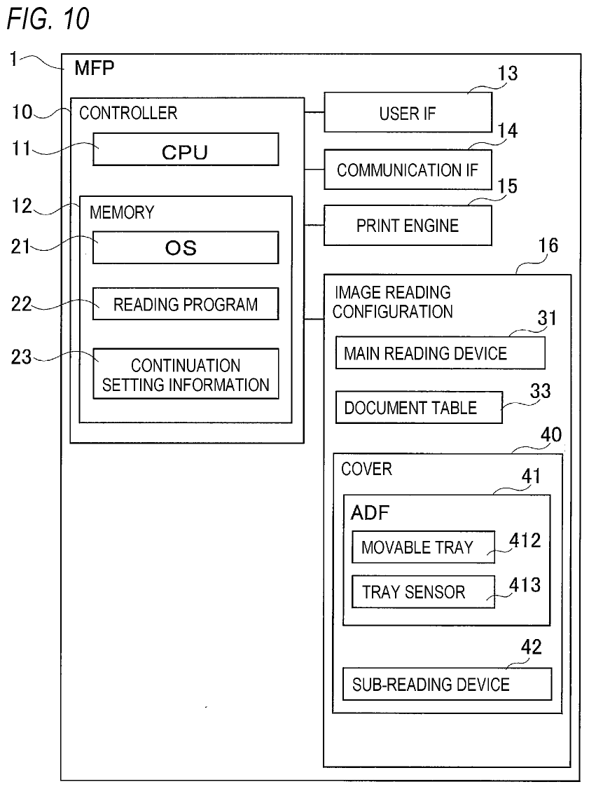

The ADF 41 of the MFP 1 according to the second embodiment includes, for example, a movable tray 412 and a tray sensor 413 as illustrated in FIG. 10. The movable tray 412 is a document tray whose inclination is changed by setting a document, and is a swingable document tray. The movable tray 412 is an example of a sheet feed tray. A maximum stacking amount, which is the maximum amount of documents that can be stacked, is set on the movable tray 412.

The tray sensor 413 is a sensor that outputs a signal based on an amount of documents placed on the movable tray 412. The tray sensor 413 outputs different signals according to, for example, the inclination of the movable tray 412 of the ADF 41. For example, the tray sensor 413 may output a different signal depending on whether the maximum stacking amount of documents are stacked on the movable tray 412. The tray sensor 413 may output a different signal depending on whether an amount of documents close to the maximum stacking amount are stacked. The tray sensor 413 may be configured by a combination of a plurality of sensors.

The MFP 1 according to the second embodiment performs the reading process illustrated in FIG. 3, similarly to the MFP 1 according to the first embodiment. When the instruction to start performing scanning is received, if documents are stacked on the ADF 41 (S111: YES), the CPU 11 performs the ADF reading process.

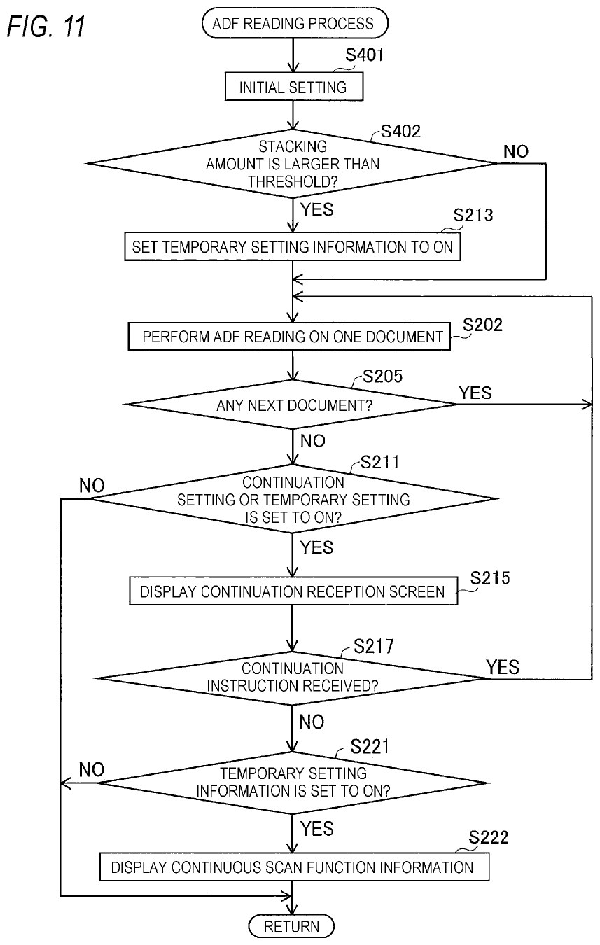

A procedure of the ADF reading process according to the second embodiment is partially different from the reading process according to the first embodiment. The procedure of the ADF reading process according to the second embodiment will be described with reference to the flowchart of FIG. 11. In FIG. 11, the same reference numerals are given to the same procedure as that of the ADF reading process according to the first embodiment illustrated in FIG. 5, and the description thereof will be omitted.

First, the CPU 11 performs an initial setting (S401). Specifically, the CPU 11 turns off the temporary setting information. The temporary setting information is information similar to the temporary setting information in the first embodiment. On the other hand, the MFP 1 according to the second embodiment does not use the counter used in the first embodiment.

Based on the output signal of the tray sensor 413, the CPU 11 determines whether the stacking amount of the documents stacked on the movable tray 412 is larger than a threshold (S402). The threshold may be the same as or different from the threshold in the first embodiment. Based on the signal output from the tray sensor 413, the CPU 11 can detect that the stacking amount of documents is larger than the threshold.

The threshold in the present embodiment may be set in advance based on the maximum stacking amount of the movable tray 412. If the threshold is set based on the maximum stacking amount of the movable tray 412, the MFP 1 can display information of the continuous scan function at an appropriate frequency as described later.

In response to determining that the stacking amount is larger than the threshold (S402: YES), the CPU 11 sets the temporary setting information to ON (S213). A condition that the stacking amount is larger than the threshold is an example of a continuation suggestion condition. The MFP 1 according to the present embodiment can determine whether the continuation suggestion condition is satisfied based on the stacking amount of the documents before the conveyance of the documents for the ADF reading is started.

Then, the CPU 11 causes the ADF 41 to convey the document and performs ADF reading (S202). The CPU 11 determines whether there is another document on the movable tray 412 based on the output signal of the tray sensor 413 (S205). The CPU 11 repeats S202 and S205 until reading of all documents set on the movable tray 412 is completed.

In response to determining that there is no document placed in the ADF 41 (S205: NO), the CPU 11 determines whether the continuation setting or the temporary setting is set to continuous ON (S211). In the present exemplary embodiment, when the stacking amount of the documents stacked on the movable tray 412 is larger than the threshold, the temporary setting information is ON in S213. When the continuation setting is continuous OFF and an amount of documents stacked on the movable tray 412 is not large (S211: NO), the CPU 11 ends the ADF reading process.

In response to determining that the continuation setting or temporary setting is set to continuous ON (S211: YES), the CPU 11 causes the user IF 13 to display the continuation reception screen 60 illustrated in FIG. 6A (S215). The CPU 11 may cause the user IF 13 to display the continuation reception screen 65 illustrated in FIG. 6B. The CPU 11 determines whether the continuation instruction is received on the continuation reception screens 60 and 65 (S217). In response to determining that the continuation instruction is received (S217: YES), the CPU 11 proceeds to S202 and subsequently performs ADF reading. When the images of all the documents stacked on the movable tray 412 are read, the CPU 11 causes the user IF 13 to display the continuation reception screens 60 and 65 again.

In response to determining that the continuation instruction is not received on the continuation reception screens 60 and 65 (S217: NO), the CPU 11 determines whether the temporary setting information is set to ON (S221). In response to determining that the temporary setting information is set to ON (S221: YES), the CPU 11 causes the user IF 13 to display the continuous scan function information screen 70 illustrated in FIG. 7A (S222). The CPU 11 may display the continuous scan function information screen 80 illustrated in FIG. 7B and receive the user operation.

After S222 or in response to determining that the temporary setting information is not set to ON (S221: NO), the CPU 11 ends the ADF reading process.

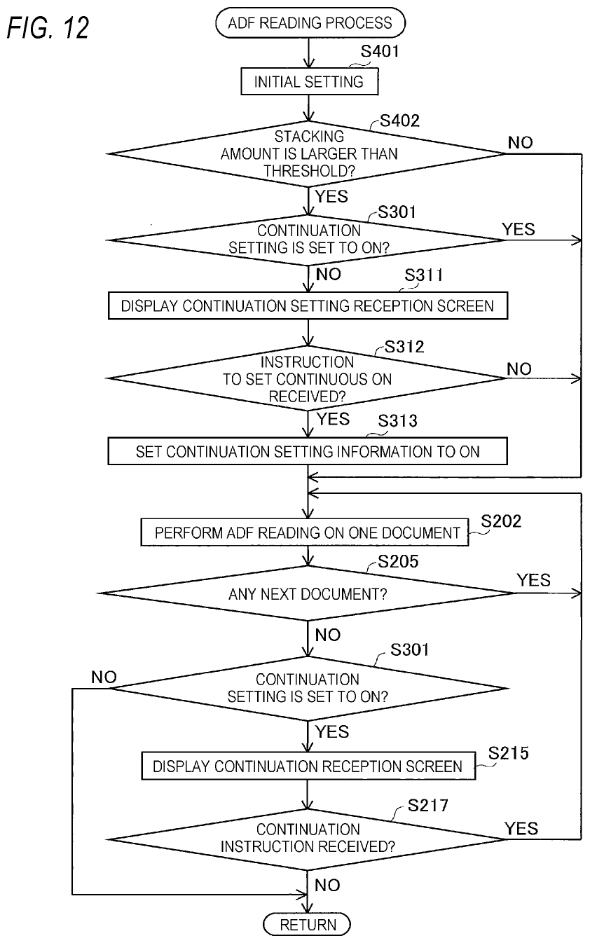

A procedure of the ADF reading process in the MFP 1 according to the second embodiment may be the procedure illustrated in the flowchart of FIG. 12. A procedure of the ADF reading process in FIG. 12 is different from that of the ADF reading process in FIG. 11 in which information is displayed after reading. In the ADF reading process of FIG. 12, the CPU 11 displays the information of the continuous scan function before starting reading. In FIG. 12, the same reference numerals are given to the same procedures as those of the ADF reading processes of FIGS. 5, 8, and 11, and the description thereof will be omitted.

In the ADF reading process of FIG. 12, the CPU 11 determines whether the stacking amount of the movable tray 412 is larger than the threshold (S402). When the stacking amount of the movable tray 412 is not larger than the threshold (S402: NO), the CPU 11 proceeds to S202 and performs ADF reading.

In response to determining that the stacking amount of the movable tray 412 is large (S402: YES), the CPU 11 determines whether the continuation setting is set to continuous ON (S301). In response to determining that the continuation setting has already been set to continuous ON (S301: YES), the CPU 11 proceeds to S202 and performs ADF reading.

In response to determining that the continuous ON is not set (S301: NO), the CPU 11 causes the user IF 13 to display the continuous scan function information screen 80 illustrated in FIG. 7B (S311). Then, the CPU 11 determines whether an instruction to set the continuous ON as the continuation setting is received (S312). In response to determining that the instruction to set the continuous ON is received (S312: YES), the CPU 11 stores information indicating the continuous ON in the continuation setting information 23 (see FIG. 10) (S313).

After S313 or in response to determining that the instruction to set the continuous ON is not received (S312: NO), the CPU 11 performs ADF reading (S202). The CPU 11 repeats conveyance and reading until reading of all documents set on the movable tray 412 is completed.

When the reading of all the documents is completed (S205: NO), the CPU 11 determines whether the continuation setting is set to continuous ON (S301). When the continuous ON is set before the start of the current reading or the instruction to set the continuous ON is received in S312, the continuation setting is set to the continuous ON. In response to determining that the continuous ON is not set (S301: NO), the CPU 11 ends the ADF reading process.

In response to determining that the continuous ON is set (S301: YES), the CPU 11 causes the user IF 13 to display the continuation reception screen 60 illustrated in FIG. 6A (S215). In response to determining that the continuation instruction is received on the continuation reception screen 60 (S217: YES), the CPU 11 proceeds to S202 and subsequently performs the ADF reading. In response to determining that an end instruction is received instead of the continuation instruction (S217: NO), the CPU 11 ends the ADF reading process.

As described above in detail, the MFP 1 according to the second embodiment displays the continuous scan function information when the continuation setting is set to continuous OFF and the number of documents stacked on the movable tray 412 is large. Therefore, similarly to the MFP 1 according to the first embodiment, the user can recognize that the MFP 1 has a continuous scan function.

Further, the MFP 1 according to the second embodiment can determine whether the number of documents set in the ADF 41 is large based on the output signal of the tray sensor 413 illustrated in FIG. 10. Therefore, the MFP 1 according to the second embodiment does not need to count the number of documents. The MFP 1 according to the second embodiment can determine that the stacking amount is large before starting the reading. On the other hand, the procedure of the first embodiment is also applicable to a model without the movable tray 412.

The above embodiments are merely an example, and do not limit the present invention. Therefore, various improvements and modifications can be naturally made to the technique disclosed in the present specification without departing from the gist of the present invention. For example, the image reading apparatus may be a device having an image reading function, and is not limited to the MFP 1, and may be a scanner, a copy machine, or a FAX device.

Further, in each of the above-described embodiments, the MFP 1 capable of performing the double-sided scanning has been described, but the setting of the continuous scanning can be applied even to a device not capable of performing the double-sided scanning. The sub-reading device 42 may not be provided in a device not capable of performing the double-sided scanning.

Further, in each embodiment, if the continuation setting is set to continuous ON, the information describing the continuous scan function is not displayed, or may be displayed. However, if the continuation setting is set to continuous ON, it can be estimated that the user has already recognized continuous reading. The frequent display is troublesome for the user who recognizes the continuous reading. On the other hand, even the user who recognizes the continuous reading may forget, and thus the display may be performed even when the continuation setting is set to continuous ON.

In each of the above-described embodiments, after performing the FB reading, the MFP 1 displays the continuation reception screen 60 (FIG. 6A) regardless of the setting of the continuous scanning and receives an instruction from the user. For example, the MFP 1 may determine whether to perform the continuous scanning based on the setting of the continuous scan even after the FB reading is performed. In addition, for example, when the MFP 1 receives an instruction to start performing scanning, if continuous ON is not set as continuous scanning, the MFP 1 may display a message for confirming that the scanning is not continued.

Further, in each embodiment, In the continuation reception screen 60 (FIG. 6A) and the continuation reception screen 65 (FIG. 6B), the MFP 1 may set “not continue” as a default, or may not set. For example, the MFP 1 may wait until a user operation on any button is received. For example, the MFP 1 may determine not to perform the continuous scanning when a predetermined time has elapsed without accepting any operation on any button.

In any flowchart or sequence diagram disclosed in the embodiments, an execution order of a plurality of processes in any plurality of steps can be freely changed or can be executed in parallel within a range in which no contradiction occurs in a process content.

The processes disclosed in the embodiments may be executed by hardware such as a single CPU, a plurality of CPUs, and an ASIC. The processes disclosed in the embodiments may be executed by a controller in which a CPU and an ASIC are combined. In addition, the processes disclosed in each embodiment can be implemented in various modes such as a recording medium in which a program for executing the processes is recorded, or a method.

The image reading apparatus disclosed in the present specification displays the continuation suggestion information to suggest the continuous reading if the continuous reading is set to be disabled and the continuation suggestion condition is satisfied. Therefore, the image reading apparatus allows the user to recognize the continuous reading. The recognized user can be expected to use continuous reading.

A control method for implementing the function of the image reading apparatus, a computer program, and a computer-readable storage medium that stores the computer program are also novel and useful.

According to the technique disclosed in the present specification, a new technique for promoting the use of continuous reading is realized in an image reading apparatus including a device that automatically conveys a document.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. An image reading apparatus comprising:
a document conveying device configured to automatically convey a document;
a user interface; and
a reading device,
the image reading apparatus being capable of causing the reading device to read an image of a document conveyed by the document conveying device and generating read data based on a reading result, the image reading apparatus being capable of performing continuation setting as to whether to enable or disable continuous reading in accordance with an operation via the user interface, wherein
the image reading apparatus is configured to:
after causing the reading device to read the image of the document conveyed by the document conveying device,
if the continuous reading is set to be enabled as the continuation setting, enter a state of waiting to receive the continuation instruction via the user interface;
when the continuation instruction is received in a state of waiting to receive the continuation instruction, cause the reading device to read an image of a next document;
when the continuation instruction is not received in a state of waiting to receive the continuation instruction, combine and output read data obtained by reading; and
if the continuous reading is set to be disabled as the continuation setting, not enter a state of waiting to receive the continuation instruction, and combine and output read data obtained by reading, and
the image reading apparatus is further configured to, if the continuous reading is set to be disabled as the continuation setting and a continuation suggestion condition is satisfied, cause the user interface to display continuation suggestion information suggesting the continuous reading.

2. The image reading apparatus according to claim 1, wherein
the image reading apparatus is configured to:
if the continuous reading is set to be disabled as the continuation setting and the continuation suggestion condition is satisfied, display the continuation suggestion information on the user interface and receive an operation of instructing the continuous reading;
when the operation to instruct the continuous reading is received, cause the reading device to read an image of the next document, and enter a state of waiting to receive the continuation instruction via the user interface after causing the reading device to read the image of the next document;
when the continuation instruction is received in the state of waiting to receive the continuation instruction, cause the reading device to read an image of a next document; and
when the continuation instruction is not received in the state of waiting to receive the continuation instruction, combine and output read data obtained by the reading.

3. The image reading apparatus according to claim 2, wherein
the image reading apparatus is configured to:
after causing the reading device to read an image of a document conveyed by the document conveying device,
if the continuous reading is set to be enabled as the continuation setting, enter a state of waiting to receive the continuation instruction by displaying, on the user interface, a first selection screen for selecting whether to continue the reading;
when the continuation instruction is received in response to reception of the selection continuing on the first selection screen, cause the reading device to read an image of a next document;
when the continuation instruction is not received in response to reception of the selection continuing on the first selection screen, combine and output the read data obtained by reading;
if the continuous reading is set to be disabled as the continuation setting and the continuation suggestion condition is not satisfied, not enter a state of waiting to receive the continuation instruction, and combine and output read data obtained by reading;
if the continuous reading is set to be disabled as the continuation setting and the continuation suggestion condition is satisfied, receive the operation of instructing the continuous reading by displaying, on the user interface, a second selection screen including the continuation suggestion information, which is a second selection screen for selecting whether to continue the reading;
when the operation of instructing the continuous reading is received in response to the reception of the selection continuing on the second selection screen, cause the reading device to read an image of a next document, display the first selection screen not including the continuation suggestion information on the user interface after causing the reading device to read the image of the next document, and enter a state of waiting to receive the continuation instruction; and
when the continuation instruction is not received in response to no reception of the selection continuing on the first selection screen or the second selection screen, combine and output read data obtained by reading.

4. The image reading apparatus according to claim 3, wherein
a default is not continued in the first selection screen and the second selection screen.

5. The image reading apparatus according to claim 2, wherein
the image reading apparatus is configured to, when the operation of instructing the continuous reading is received, automatically change a setting of the continuous reading to be enabled.

6. The image reading apparatus according to claim 2, wherein
the image reading apparatus is configured to:
when the operation of instructing the continuous reading is received, receive an operation of changing the setting of the continuous reading to be enabled; and
when the operation of changing the setting of the continuous reading to be enabled is received, change the setting of the continuous reading to be enabled.

7. The image reading apparatus according to claim 2, wherein
the image reading apparatus is configured to,
before the continuous reading is set to be disabled as the continuation setting and conveyance of a document by the document conveying device is started,
display the continuation suggestion information on the user interface and receive the operation of instructing the continuous reading if the continuation suggestion condition is satisfied.

8. The image reading apparatus according to claim 2, wherein
the image reading apparatus is configured to,
after causing the reading device to read the image of the document conveyed by the document conveying device,
if the continuous reading is set to be disabled as the continuation setting and the continuation suggestion condition is satisfied, display the continuation suggestion information on the user interface and receive the operation of instructing the continuous reading.

9. The image reading apparatus according to claim 1, wherein
the image reading apparatus is further configured to, if the continuous reading is disabled as the continuation setting and the continuation suggestion condition is satisfied, display information describing a function of the continuous reading on the user interface as the continuation suggestion information.

10. The image reading apparatus according to claim 9, wherein
the image reading apparatus is configured to,
after causing the reading device to read the image of the document conveyed by the document conveying device,
if the continuous reading is set to be disabled as the continuation setting and the continuation suggestion condition is satisfied, display the information describing the function of the continuous reading on the user interface as the continuation suggestion information.

11. The image reading apparatus according to claim 10, wherein
the image reading apparatus is configured to:
after causing the reading device to read the image of the document conveyed by the document conveying device,
if the continuous reading is set to be disabled as the continuation setting and the continuation suggestion condition is satisfied, receive the operation of instructing the continuous reading by displaying, on the user interface, a selection screen for selecting whether to continue the reading;
when the operation of instructing the continuous reading is received in response to reception of the selection continuing on the selection screen, display the information describing the function of the continuous reading on the user interface as the continuation suggestion information, and cause the reading device to read an image of a next document; and
when the operation of instructing the continuous reading is received in response to no reception of the selection continuing on the selection screen, not display the continuation suggestion information, and combine and output read data obtained by reading.

12. The image reading apparatus according to claim 1, wherein
the continuation suggestion condition is that an amount of documents to be read exceeds a predetermined amount.

13. The image reading apparatus according to claim 12, further comprising:
a sensor configured to output a signal based on an amount of documents placed on a sheet feed tray of the document conveying device, wherein
the image reading apparatus is configured to, when the continuation setting is set to be disabled as the continuous reading and it is detected that the amount of documents placed on the sheet feed tray of the document conveying device exceeds the predetermined amount based on the signal output from the sensor, display the continuation suggestion information on the user interface.

14. The image reading apparatus according to claim 12, wherein
the image reading apparatus is configured to count the number of documents conveyed by the document conveying device, and
the image reading apparatus is further configured to, if the continuous reading is set to be disabled as the continuation setting and the number of counted documents exceeds a threshold number corresponding to the predetermined amount, display the continuation suggestion information on the user interface.

15. The image reading apparatus according to claim 12, wherein
the image reading apparatus is configured to receive a setting of a threshold corresponding to the predetermined amount, and
the image reading apparatus is further configured to, if the continuous reading is set to be disabled as the continuation setting and the amount of documents to be read exceeds the threshold, display the continuation suggestion information on the user interface.

16. The image reading apparatus according to claim 12, wherein
in the image reading apparatus, a threshold corresponding to the predetermined amount is set in advance based on a maximum stacking amount of a sheet feed tray of the document conveying device, and
the image reading apparatus is further configured to, if the continuous reading is set to be disabled as the continuation setting and the amount of documents to be read exceeds the threshold, display the continuation suggestion information on the user interface.
